(19) United States
(12) Patent Application Publication
(10) Pub. No.: US 2003/0187781 A1
(43) Pub. Date: Oct. 2, 2003

(54) Method and system for processing card reissue transactions

(75) Inventors: Rebecca Goodman, Omaha, NE (US); Jim K. Prendergast, Omaha, NE (US); Michelle Buggs, Omaha, NE (US); Sharon K. Hogan, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/108,806

(22) Filed: Mar. 26, 2002

(51) Int. Cl. G06F 17/60

(52) U.S. Cl. 705/39

(57) ABSTRACT

A method and system for reissue processing for card issuance units (CIUs) such as credit cards, smart cards, phone cards and the like. Prior to expiration of the credit card, cardholder accounts in good standing are identified. Thereafter, uncompleted records for the cardholders are provided. The uncompleted record contains minimal account information about the cardholder. Thereafter, the method includes evaluating whether the cardholder accounts are eligible for credit card reissue when the uncompleted records are selected. The cardholder accounts are evaluated by running the records through client defined criteria. After evaluation, if the cardholder accounts are eligible, completed records of cardholders are generated for fulfilling the credit cards.

### CROSS-REFERENCES TO RELATED APPLICATIONS

This application is a continuation in part of U.S. application Ser. No. ______, entitled “System for Card Processing, Embossing and Fulfillment”, filed ______, the complete disclosure of which is herein incorporated by reference.

### BACKGROUND OF THE INVENTION

This invention relates generally to the field of card issuance units. More specifically, the invention relates to reissue processing and fulfilling of card issuance units (e.g., credit cards, smart cards, phone cards and the like).

Reissue processing refers to renewal of card issuance units (CIUs) prior to expiration. CIU are credit cards, smart cards or the like, alone, or in combination with card carriers, personal information number mailers, etc. CIU are typically provided by institutions to their customers. For example, a bank may issue a credit card for use by its customer upon credit approval. These credit cards may be produced by third parties often unrelated to the institution. When a credit card is desired, the institution forwards the cardholder's information to the third party for embossing. The third party then embosses the cardholder information on the credit card, all on behalf of the institution. Embossing refers to imprinting the cardholder's name and account number, etc., on the credit card. After embossing, the credit card can now be forwarded to the cardholder for use.

As generally known, credit cards often expire after a certain duration and must be renewed. Prior to expiration, the cardholder's reissue embossing record may be generated by the third party. If the cardholder's account is eligible, a new credit card is embossed and issued to replace the old one. However, in some instances, during reissue processing, the cardholder account may become ineligible after the credit card is renewed. This is because reissue processing takes a relatively long time, enough time for the cardholder account to become ineligible. Because the cardholder account is no longer eligible, the credit card is destroyed. This can result in significant waste of materials and other valuable resources.

Therefore, there is a need to resolve one or more of the aforementioned problems relating to conventional systems for reissuing credit cards, and the present invention meets this need.

### BRIEF SUMMARY OF THE INVENTION

The invention provides reissue processing for card issuance units (CIUs) such as credit cards, smart cards, phone cards and the like. CIUs such as credit cards typically expire after a certain duration and must be renewed. Reissue processing is the process of renewing such CIUs. The invention is operable using a suitably programmed computing device.

In one embodiment, the invention is a method for reissuing credit cards to cardholders. Prior to expiration of the credit card, cardholder accounts in good standing are identified by the computing device. As used herein, good standing refers to cardholder accounts that qualify for reissue based on various criteria. Further, good standing may refer to those cardholder accounts with good credit risk. After cardholder accounts in good standing are identified, uncompleted records for such cardholders on those accounts are generated. The uncompleted records contain minimal account information about the cardholders. The purpose of using uncompleted records rather than completed records is two fold. First, the production facility uses the uncompleted records for estimating the future amount of work to be performed. This function does not need completed records. Second, at this stage, the uncompleted records are used to select cardholder accounts for a second evaluation. Again, completed records are not required for this task.

After generation, the uncompleted records are selected to evaluate whether the cardholder accounts are eligible for credit card reissue. In one embodiment, the accounts are evaluated by running them through a product control file. This file typically contains one set of parameters for determining cardholder accounts eligibility. Such criteria includes number of times delinquent or number of times overlimit, or number of times both delinquent and overlimit, percent overlimit, and state of residence. By comparing cardholder information to the eligibility criteria, reissue qualification is determined.

Another technique for identification is to employ an adaptive control system (ACS) for determining reissue criteria. ACS contains various sets of criteria. One criteria is reissue eligibility criteria, and a second criteria is CIU Reissue Review eligibility criteria. Also, ACS may examine cardholder patterns and assign a behavioral score. For example, ACS may compare spending habits, high balance, lateness, etc. and assign a behavior score for determining whether the cardholder account is eligible for reissue. It should be noted that with either ACS or PCF, the cardholder accounts validate against client-specified criteria.

After evaluation, completed records are generated for all reissue eligible cardholders in order to fulfill the credit cards. Typically, the completed records contain all of the information reasonably necessary for embossing the credit card. In this manner, the credit cards are embossed and fulfilled at the right time for mailing to cardholders. Further, because the records are completed when the production facility has capacity, the most current cardholder information is used for completing the fulfillment process. After the credit cards are embossed, they are mailed to the appropriate cardholders.

In an alternate embodiment, the present invention is a method for reissuing CIUs such as credit cards, smart cards, etc. to cardholders. The method includes evaluating a record for an account for a first time to determine whether the account is eligible for reissue. The first evaluation typically occurs at month end processing, typically, two months before the credit card is due to expire. Later, when the production facility has sufficient resources to fulfill the CIU, the account is evaluated a second time to determine whether the account is still eligible for reissue. In this manner, if the account becomes ineligible in the interim, CIU fulfillment is deferred. Evaluation may be implemented using client-defined criteria. After evaluation, if the accounts remain eligible after the second time, the CIUs are embossed and mailed to the cardholders.

A further aspect of the present invention is a system for reissuing cards to cardholders. The system includes a product control file containing reissue criteria and software for generating records for accounts in good standing. In addition, the system includes software for evaluating the account for a first time. The account is evaluated by running it through the product control file to determine whether the account is eligible. Another component of the system is software for evaluating the account a second time to determine whether the account is still eligible for reissue. If eligible, the CIU record is forwarded to a production facility for embossing and fulfilling. Immediately, or shortly after the card is fulfilled, it is forwarded to the cardholder. In this fashion, little or no time elapses between when the card is fulfilled and when it is mailed to the cardholder.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a CIU system for processing reissue requests according to a first embodiment of the present invention.

FIG. 2 is illustrates a method for processing reissue requests according to an embodiment of the present invention.

### DETAILED DESCRIPTION OF THE INVENTION

The invention provides reissue processing for card issuance units (CIUs). A CIU may be a credit card, a smart card or the like, alone, or in combination with a card carrier, a personal information number mailer, etc. CIUs such as credit cards are usually provided by institutions to their customers. Conveniently, the credit cards may be produced by third parties often unrelated to the institution. When a credit card is desired by the institution, the third party completes the CIU on behalf of the institution.

Similarly, about two months prior to expiration of the credit cards, the third party may begin reissue processing to renew credit cards for eligible cardholders. This specification discloses systems and methods for reissue processing by the third party. The methods are operable using a suitably programmed computing device. Prior to expiration of credit cards, accounts in good standing are identified. Thereafter, uncompleted records for the cardholders are provided.

The uncompleted record may contain account information such as an account number or name of the cardholder. Uncompleted records are used because completed records are not needed until the cards are fulfilled. This fulfillment occurs later in the process when the production facility has sufficient resources to fulfill the cards. In any event, the uncompleted records are used for selecting cardholder accounts to begin the reissue process. Further, such records are used by the production facility to estimate records for future fulfillment. Upon providing the uncompleted records, the method includes evaluating whether the cardholder accounts are eligible for credit card reissue.

The accounts are evaluated by running the accounts either through a product control file containing eligibility criteria or an adaptive control system for evaluating reissue criteria, or other client defined criteria is employed. After evaluation, if the cardholder accounts are eligible, completed records for cardholders are generated for fulfilling the credit cards. Completed records contain not only all of the information reasonably necessary for embossing the credit cards, but also, these records are generated with the most current information. In this manner, the credit cards are fulfilled and mailed to cardholders with the most current cardholder information. For ineligible cardholder accounts, a reinstate date is provided on which eligibility is reevaluated. If ineligible cardholder accounts become eligible, their records are sent for fulfillment. Fulfillment is further described in U.S. application Ser. No. ______, entitled “System for Card Processing, Embossing and Fulfillment”, filed ______. The complete disclosure of that application is incorporated herein by reference.

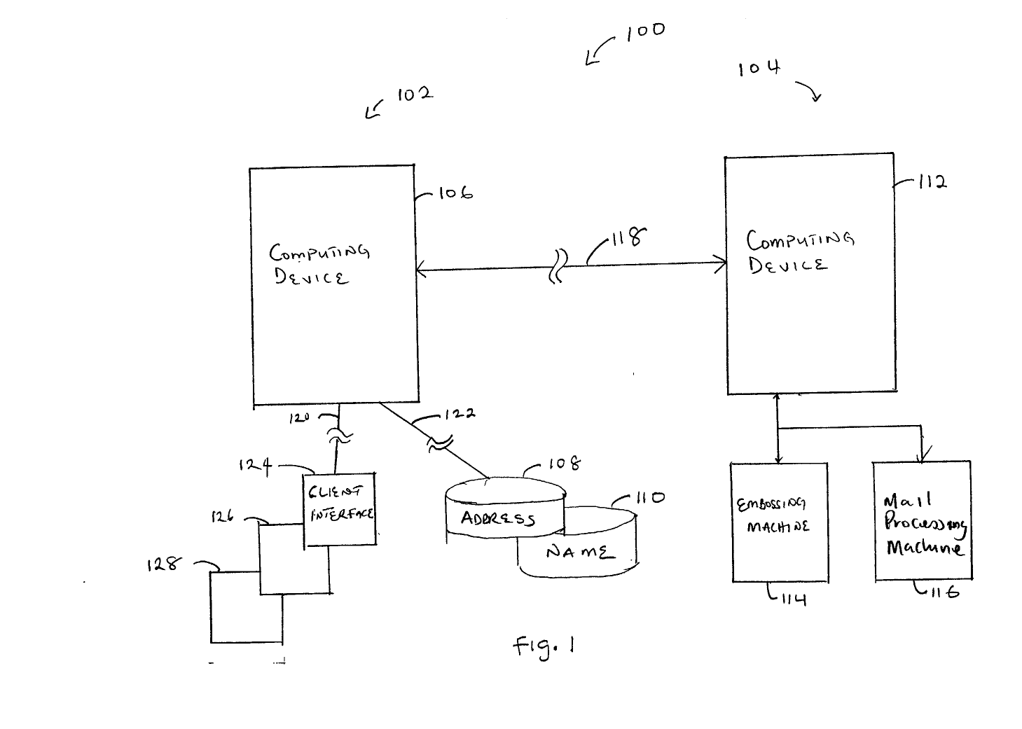

FIG. 1 illustrates a CIU system for processing reissue requests according to a first embodiment of the present invention. Among other components, CIU system 100 comprises a mainframe system 102 and a production facility system 104. Mainframe system 102 comprises a first computing device 106 for electronically receiving modifications to cardholder records from client interfaces 124, 126, 128; and for building information necessary for fulfilling reissue transactions. Computing device 106 may be a VAX/VMS or the like available from DEC® (Digital Equipment Corporation). Mainframe system 102 further comprises an address database 108 for storing cardholder addresses and a name database 110 for storing cardholder names.

Production facility system 104 comprises a second computing device 112 for fulfilling reissue transactions in conjunction with first computing device 106; and an embossing machine 114 for embossing CIUs with cardholder information. Production facility system 104 further includes a mail processing machine 116 for generating card carriers, and for attaching the carriers to CIUs. These are inserted along with other CIU components into an envelope for mailing to the cardholder. Computing device 112 is typically an AS/400 computing device by IBM® (International Business Machines). One of ordinary skill in the art will realize that other computing devices within the spirit and scope of the present invention may be employed.

Computing device 106 is communicably coupled to computing device 112 via a communication link 118. Communication link 118 may be a cable (e.g., RS232) or wireless link for example.

In use, before a credit card expires, cardholder reissue records are generated for accounts in good standing. Typically, the records are generated by mainframe 106 two months prior to expiration. The records contain cardholder information from various databases. These databases include address database 108 (FIG. 1) for storing cardholder addresses, and name database 110 for storing cardholder names. Although not shown, various other types of information may be stored in other databases. After the cardholder records are generated, they are forwarded to the production facility.

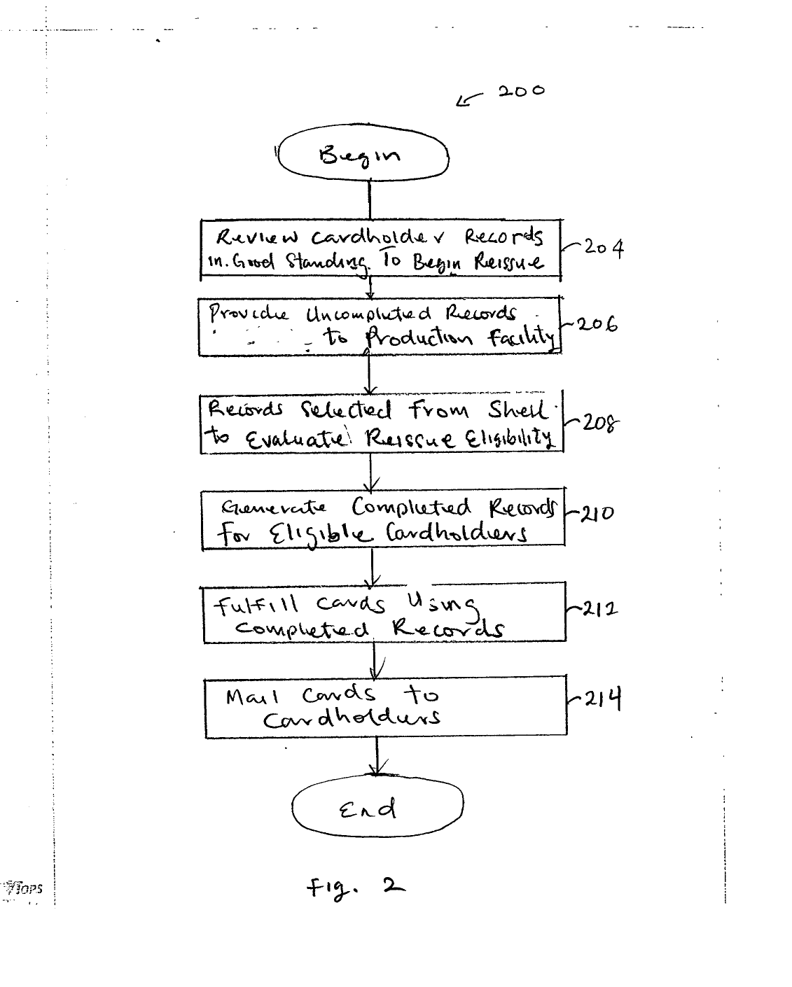

At the facility, the records are selected to begin the embossing process as further described with reference to FIG. 2. The records are selected via AS/400 112 which communicates with mainframe 106 to obtain the selected records. Although not necessary, the record is typically selected when the production facility has the capacity (equipment, personnel, etc.) to begin fulfillment of the credit card. Fulfillment includes imprinting personalization information such as name, account number, expiration date, encoding information, etc., on the credit card by embossing machine 114.

Further, this fulfillment often occurs much later after the CIU record is first generated. This is due to resource allocation wherein the production facility needs to find resources to fulfill the work order. When such resources are available, selected records are run through an eligibility process to determine whether the cardholder accounts are still eligible for reissue, in accordance with one embodiment of the present invention. If the cardholder accounts remain eligible, records are forwarded to the production facility for fulfillment. If ineligible, eligibility review is deferred until a later date known as a “reinstate” day. This date is designated by the client for processing accounts found ineligible during the prior review processes.

Fulfillment may be implemented using embossing machine 114 and mail processing machine 116. Embossing machine 114 receives cardholder information such as names, account numbers, expiration dates, encoding information, etc. These are physically imprinted on the credit cards. Mail processing machine 116 receives card carrier information such as mailing addresses, account numbers, primary cardholder names, credit limits, etc. for printing on card carriers. Next, credit cards and card carriers are matched for insertion into envelopes, and for mailing to cardholders. It should be observed that inserts, letters, and other marketing materials may be inserted along with the card for mailing to the cardholders.

Mail processing machine 116 includes components for achieving this function. Although not shown, such components may include a paper feeding mechanism for feeding sheets into a bin for receiving paper from the paper feeding mechanism; and a printer for printing alpha-numeric characters on the paper. One non-limiting example of how mail processing machine 116 may be constructed is disclosed in a U.S. application Ser. No. ______ entitled “Systems and Methods for Providing Inserts into Envelopes,” filed Nov. 8, 2001 by the assignee of the present invention (attorney docket no. 20375-17), the aforementioned application being hereby incorporated by reference as if fully set forth in the present invention. While the above description references credit cards, one of ordinary skill in the art will realize that the present invention applicable to other polymer type cards namely smart cards, phone cards and the like.

FIG. 2 illustrates a method 200 for reissue processing to renew CIUs in accordance with an embodiment of this invention. Method 200 is implemented by system 100 of FIG. 1.

At block 204, reissue processing begins prior to expiration of a CIU such as a credit card. This process may be initiated at month end processing, typically two months before a credit card expires. In this manner, sufficient time in advance of expiration is provided not only for processing but also for mailing the new card to the cardholder.

Once reissue processing is initiated, one or more cardholder accounts in good standing are identified by system 100. These cardholder accounts are identified as being potentially eligible for reissue. As used herein, good standing refers to cardholder accounts that qualify for reissue based on various criteria. Further, good standing may refer to those cardholder accounts with good credit risk. One technique for identification is to run account information through a product control file (PCF). Although PCF generally contains parameters to control various segments of CIU processing, it may include eligibility criteria for determining whether accounts are in good standing, and are potentially eligible for reissue. Such criteria may include number of times delinquent or number of times overlimit, or number of times both delinquent and overlimit, percent overlimit, and state of residence. Further, such eligibility criteria may be provided either by the client or by a third party. In addition, account limits, delinquency limits, etc., may be specified in PCF along with the eligibility criteria.

Another technique for identification is to employ an adaptive control system (ACS). ACS contains software instructions with a number of options. These criteria include a behavioral score based on cardholder patterns. For example, for credit cards, ACS compares spending habits, high balance, lateness, etc. and assigns a behavior score for determining whether the cardholder is eligible for reissue. While ACS examines lower level details, PCF uses higher level information about cardholder accounts. It should be noted that with either ACS or PCF, the cardholder accounts validate against client-specified criteria.

At block 206, a summary of uncompleted records are provided to the production facility by mainframe 106 in form of a shell summary row that groups records having the same characteristics. The summary row is further described the U.S. application Ser. No. ______, entitled “System for Card Processing, Embossing and Fulfillment”, filed ______, the complete disclosure of which is herein incorporated by reference.

At block 208, uncompleted records are selected by production facility system 104 operators for reissue processing. Records are selected via AS/400 112 which communicates with mainframe 106 to obtain the selected records. These records are typically selected when there are resources (equipment, personnel, etc.) to fulfill credit cards. Herein lies one advantage of the present invention. Records are evaluated at the right time, when credit cards can be fulfilled. Records are not evaluated many days or perhaps months before credit cards are fulfilled, and mailed to cardholders.

When selected, accounts are evaluated to determine whether the cardholders are eligible for credit card reissue. The second eligibility review process uses PCF or ACS as described above, or other client defined criteria. Further, this process occurs during the CREATE process as further described in the herein identified parent application.

At block 210, if accounts remain eligible, complete CIU records are generated and forwarded to the production facility for reissue. If the accounts are ineligible, eligibility review is deferred until the “reinstate” day. If found eligible, completed CIU records are forwarded to the production facility for fulfilling.

At block 212, the cards are fulfilled by the production facility with the completed records. After fulfillment, the card credits are matched with card carriers for insertion into envelopes. Also, marketing inserts may be inserted into the envelopes. The fulfillment process is discussed in U.S. application Ser. No. ______, entitled “System for Card Processing, Embossing and Fulfillment”, filed ______, the complete disclosure of which is herein incorporated by reference.

At block 214, the fulfilled credit cards are mailed to the cardholders. Advantageously, in the present invention, credit cards are fulfilled and mailed immediately or shortly after eligibility review. In this manner, cards are fulfilled when resources are available, and thereafter immediately mailed out to cardholders. Fulfilled cards are not retained for days, for mailing at a future date.

In addition, there is no need for evaluation of cardholder accounts after the cards are fulfilled because cardholder records are evaluated at the right time, and mailed after fulfillment. This results in significant savings in materials, labor and other valuable resources. Cards need not be fulfilled and thereafter discarded when cardholders become ineligible. Further, as noted, the most current information available is used for fulfillment, thus, avoiding the need for discarding or rerouting after cards are fulfilled.

In this fashion, the present invention provides a method and system for card processing embossing and fulfillment. While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. A method for reissuing credit cards to cardholder accounts, the method comprising:
identifying one or more cardholder accounts in good standing;
providing an uncompleted record for the cardholder account;
evaluating whether the cardholder account is eligible for credit card reissue when the uncompleted record is selected;
generating a completed record if the cardholder account is eligible; and
fulfilling the credit card using the completed record.

2. The method of claim 1 further comprising providing a reinstate date for reevaluating the cardholder account if the cardholder account is found ineligible.

3. The method of claim 1 wherein the uncompleted record contains minimal account information for identifying the cardholder.

4. The method of claim 1 wherein the completed record contains all of the information for embossing the credit card.

5. The method of claim 1 wherein the act of evaluating further comprises running account information through a file having client defined criteria.

6. The method of claim 1 wherein the act of identifying further comprises running account information through an adaptive control system.

7. The method of claim 1 wherein the act of identifying further comprises running account information through a product configuration file.

8. The method of claim 1 wherein the act of evaluating further comprises running account information through an adaptive control system.

9. The method of claim 1 wherein the completed record contains all of the information for completing the credit card.

10. The method of claim 1 wherein the act of evaluating further comprises selecting the uncompleted record from a summary row available to a production facility.

11. A method for reissuing cards to cardholders, the method comprising:
evaluating a record for a cardholder account for a first time to determine whether the cardholder account is eligible for reissue;
evaluating the record a second time to determine whether the cardholder account is still eligible for reissue; and
embossing the card for reissue, if the cardholder account remains eligible after the second evaluation.

12. The method of claim 11 further comprising forwarding, immediately or shortly after the act of fulfilling, the card to the cardholder.

13. The method of claim 11 further comprising providing a summary row from which records are selectable.

14. The method of claim 11 wherein both acts of evaluating further comprises running account information about the cardholder account through an adaptive control system.

15. A system for reissuing cards to cardholders, the system comprising:
a product control file having one or more reissue criteria;
one or more software instructions for generating a record for one or more cardholder accounts in good standing;
one or more software instructions for evaluating the cardholder account for a first time by running the cardholder account through the product control file to determine whether the cardholder account is eligible;
one or more software instructions for evaluating the cardholder account a second time to determine whether the cardholder account is still eligible for reissue; and
one or more software instructions to assist embossing a card using the record if the cardholder account remains eligible after the second evaluation.

16. The system of claim 15 further comprising an embossing machine for embossing the card based on the record.

17. The method of claim 1 further comprising generating records for all cardholder accounts found eligible, and grouping the records into two or more groups.

18. A method for reissuing credit cards to one or more cardholder accounts, the method comprising:
evaluating a record for a cardholder account to determine whether the cardholder account is eligible for reissue;
providing an uncompleted record for the cardholder account;
generating a completed record when sufficient material for fulfilling the record is available; and
fulfilling the credit card using the completed record.

19. The system of claim 18 further comprising providing an embossing machine for embossing the credit card based on the record.
